(19) United States
(12) Patent Application Publication
(10) Pub. No.: US 2004/0215381 A1
(43) Pub. Date: Oct. 28, 2004

(54) Seat occupant identifying apparatus designed to compensating for aging-caused error

(75) Inventors: Akinori Jitsui, Okazaki-shi (JP); Satoshi Goshima, Tokyo (JP)

Correspondence Address: POSZ & BETHARDS, PLC, 11250 ROGER BACON DRIVE, SUITE 10, RESTON, VA, 20190, US

(73) Assignees: DENSO CORPORATION; FUJI JUKOGYO KABUSHIKI KAISHA

(21) Appl. No.: 10/804,207

(22) Filed: Mar. 19, 2004

(30) Foreign Application Priority Data
Mar. 20, 2003 (JP) 2003-77377

(51) Int. Cl. B60R 21/32; B60R 21/01

(52) U.S. Cl. 701/45; 280/735

(57) ABSTRACT

A seat occupant identifying apparatus for automotive occupant restraint system is provided which is designed to identify whether a seat occupant is an adult or a child based on comparison of an output of a seat load sensor with an adult identifying threshold value. The seat occupant identifying apparatus works to correct the adult identifying threshold value based on a drift of the output of the seat load sensor when the seat is unoccupied which arises aging of the apparatus, thereby compensating for an aging-caused error in identifying the seat occupant.

### BACKGROUND OF THE INVENTION

1. Technical Field of the Invention

The present invention relates generally to a seat occupant identifying apparatus designed to identify whether an occupant on a seat is an adult or a child, and more particularly to such a seat occupant identifying apparatus designed to compensate for an error in identifying a seat occupant which arises from the aging of a seat sensor.

2. Background Art

Japanese Patent First Publication No. 9-207638 teaches a seat occupant identifying apparatus which works to identify, as shown in FIG. 6(a), whether an occupant on a seat is an adult or a child by comparing a weight load of the occupant, as measured by a load sensor, with an adult identifying threshold value. The curve 101 indicates a change in output of the load sensor when an adult passenger is on the seat. The curve 102 indicates a change in output of the load sensor when a child passenger is on the seat.

A zero-point 100 that is an output of the load sensor when the seat is unoccupied by any vehicle passenger is usually drifted due to the aging of a vehicle body, the seat, a seat frame, and/or the load sensor.

For instance, when the zero-point 100 has increased, as shown in FIG. 6(b), after a lapse of a few years, it may cause the curve 100 to have a value greater than the adult identifying threshold value, so that a child on the seat is determined in error as an adult. Correction of such an error requires adjustment of the adult identifying threshold value or replacement of the load sensor periodically.

### SUMMARY OF THE INVENTION

It is therefore a principal object of the invention to avoid the disadvantage of the prior art.

It is another object of the invention to provide a seat occupant identifying apparatus which is designed to minimize an aging-caused error in identifying the type of a person on a seat.

According to one aspect of the invention, there is provided a seat occupant identifying apparatus which may be employed to activate an automotive occupant restraint system such as an airbag system based on the type of a passenger on a seat. The seat occupant identifying apparatus comprises: (a) a load sensor responsive to a physical load acting on a seat of a vehicle which arises from occupancy of the seat by a passenger to provide an output indicative thereof; (b) a seat occupant identifying circuit working to identify the passenger on the seat based on comparison of the output of the load sensor with a passenger identifying threshold value; (c) an aging-caused drift estimating circuit working to estimate an aging-caused drift of an actual output of the load sensor when the seat is unoccupied which arises from aging of the load sensor; and (d) a threshold correcting circuit working to correct the passenger identifying threshold value based on the aging-caused drift estimated by the aging-caused drift estimating circuit. This compensates for an error in identifying the passenger on the seat which arises from the aging of the apparatus, thereby ensuring the stability of operation of the apparatus.

In the preferred mode of the invention, the aging-caused drift estimating circuit is designed to perform a sampling function of sampling an output of the load sensor in a given sampling cycle, a seat unoccupancy determining function of determining whether the seat is unoccupied or not every sampling cycle, an averaging function of averaging the outputs of the load sensor sampled by the sampling function when it is determined by the seat unoccupancy determining function that the seat is unoccupied to produce an average value, and an aging-caused drift estimating function of estimating the aging-caused drift based on the average value. Specifically, the averaging function averages the outputs of the load sensor over a given number of the sampling cycles to determine a change in the drift of the output of the load sensor with time, thereby increasing the accuracy of determining the amount of correction of the adult identifying threshold value.

The aging-caused drift estimating circuit may be implemented by a microcomputer which is actuated every sampling cycle regardless of a position of an ignition switch of the vehicle.

The threshold correcting circuit works to correct the passenger identifying threshold value using a correction value which is provided by the aging-caused drift estimated by the aging-caused drift estimating circuit. The correction value is limited to within a range between an upper and a lower limit of the aging-caused drift. This prevents a change in the output of the load sensor, which is actually taken place in a condition below, from being determined as having arisen from the aging of the load sensor, which results in an excessive increase in the correction value. Such a change occur, for example, in a case where baggage is placed on the seat for a long time or a foreign matter is caught in a frame of the seat.

The seat unoccupancy determining function may determine that the seat is being unoccupied when at least one of conditions are encountered in which an ignition key of the vehicle is in an off-state and in which a seat belt for the seat is unfastened.

The averaging function may be implemented by a digital low pass filter.

A time constant used in the digital low pass filter may be selected from a range of several months to several years.

The time constant may be changed continuously or stepwise as a function of an elapsed time since the passenger identifying threshold value is preset by a manufacturer of the seat occupant identifying apparatus.

### BRIEF DESCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a perspective view which shows an occupant restraint system equipped with a seat occupant identifying apparatus according to the invention;

FIG. 2 is a block diagram which shows an occupant restraint system equipped with a seat occupant identifying apparatus of the invention;

FIGS. 3 and 4 show a flowchart of a program executed by the seat occupant identifying apparatus, as illustrated in FIGS. 1 and 2, to correct an adult identifying threshold value for compensating for an aging-cause error in identifying the type of an occupant on a seat;

FIG. 5 is a time chart which shows an example of an operation of the seat occupant identifying apparatus as illustrated in FIGS. 1 and 2;

FIG. 6(a) is a time chart which shows an example of an operation of a conventional seat occupant identifying system immediately after production thereof; and

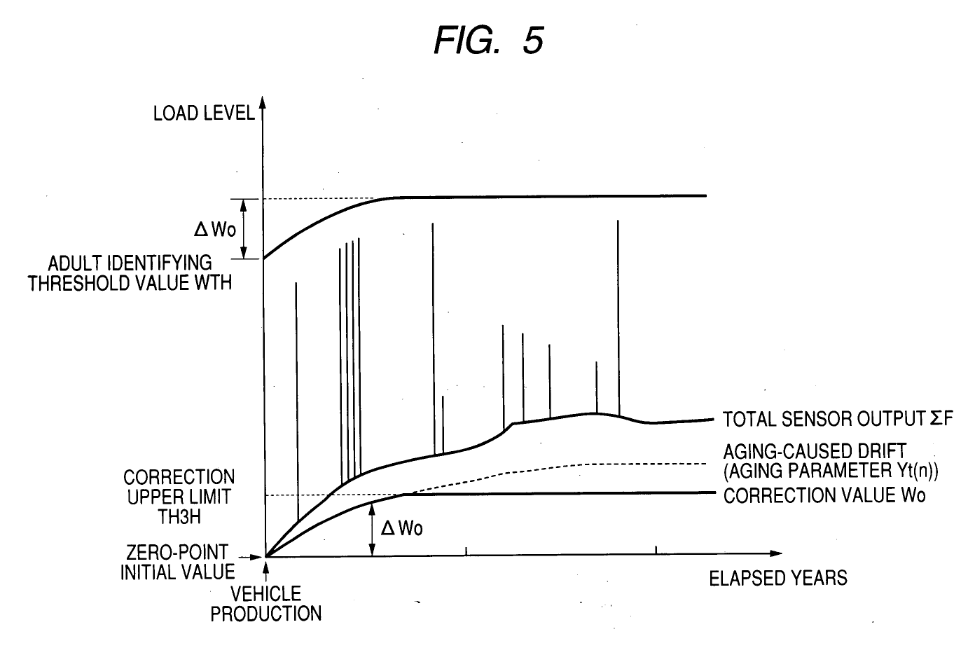

FIG. 6(b) is a time chart which shows an example of an operation of a conventional seat occupant identifying system after an elapse of a few years.

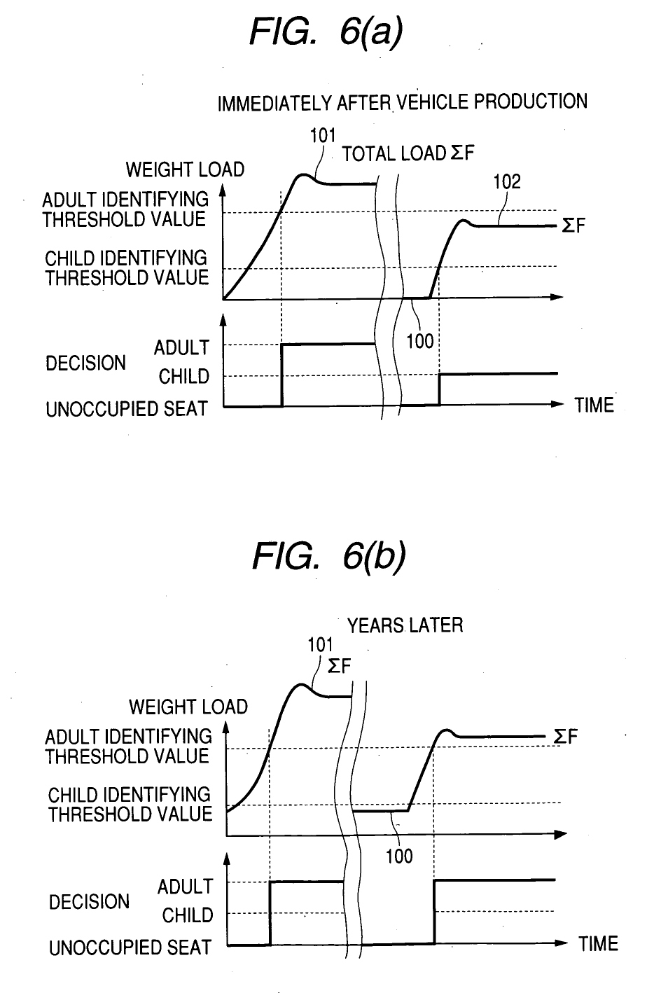

### DESCRIPTION OF THE PREFERRED EMBODIMENTS

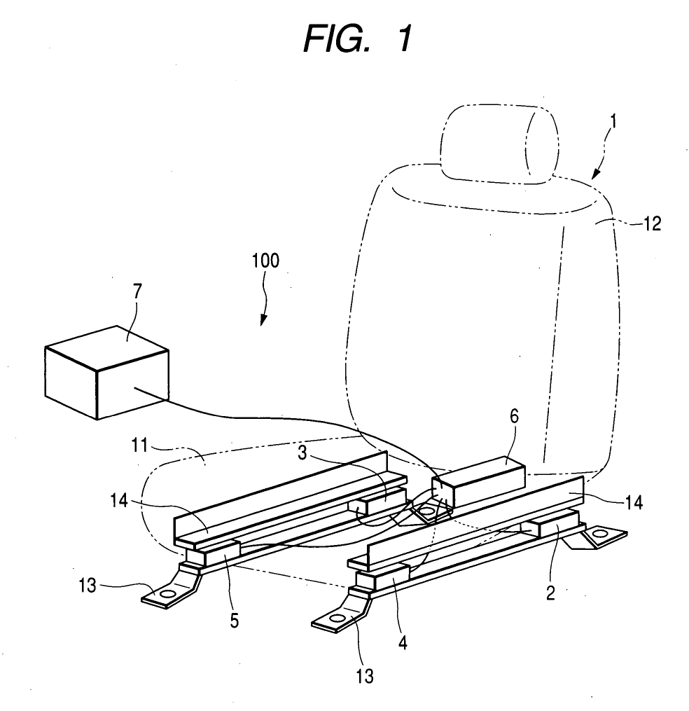

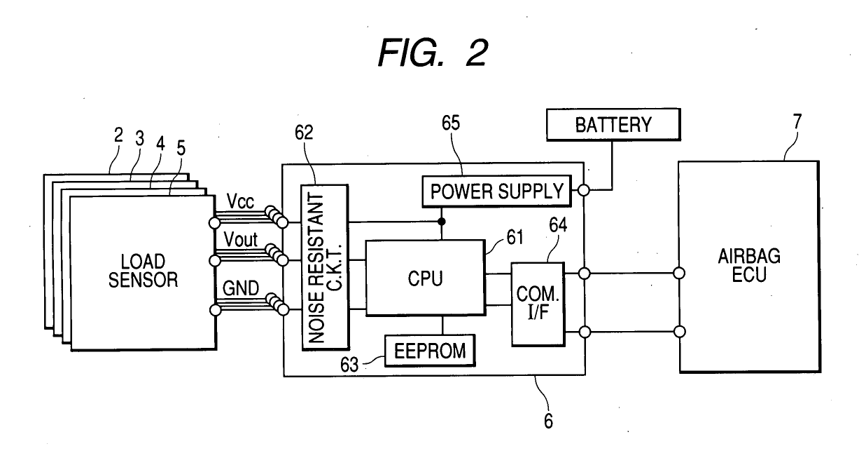

Referring to the drawings, wherein like reference numbers refer to like parts in several views, particularly to FIGS. 1 and 2, there is shown an occupant restraint system 100 according to the first embodiment of the invention which may be employed in protecting an occupant of a motor vehicle during a crash.

The occupant restraint system 100 generally includes load sensors 2, 3, 4, and 5 installed beneath a passenger seat 1, a seat occupant identifying electronic control unit (ECU) 6, an airbag electronic control unit (ECU) 7, and an airbag (not shown). The seat occupant identifying ECU 6 works to identify whether a passenger or occupant on the seat 1 is a person of more than a preselected weight (i.e., an adult) or a person of less than the preselected weight (i.e., a child) using outputs of the load sensors 2 to 5. The airbag ECU 7 works to control deployment of the airbag in response to a trigger signal outputted from the seat occupant identifying ECU 6.

The seat 1, as illustrated, is a front passenger seat of a motor vehicle which is made of up a seat cushion 11 bearing the buttocks of the occupant and a seat back 12 supporting the back and head of the occupant.

The seat cushion 11 is secured at a bottom thereof to seat upper frames 14 extending longitudinally of a vehicle body in parallel to each other. The seat upper frames 14 are disposed above seat lower frames 13, respectively. The seat lower frames 13 are joined to a floor pan of the vehicle body.

The load sensor 2 is interposed between a rear end of the left seat lower frame 13 and a rear end of the left seat upper frame 14 and works to measure a weight load of the occupant applied to a rear left portion of the seat 1 and outputs a signal indicative thereof to the seat occupant identifying ECU 6.

The load sensor 3 is interposed between a rear end of the right seat lower frame 13 and a rear end of the right seat upper frame 14 and works to measure the weight load of the occupant applied to a rear right portion of the seat 1 and outputs a signal indicative thereof to the seat occupant identifying ECU 6.

The load sensor 4 is interposed between a front end of the left seat lower frame 13 and a front end of the left seat upper frame 14 and works to measure a weight load of the occupant applied to a front left portion of the seat 1 and outputs a signal indicative thereof to the seat occupant identifying ECU 6.

The load sensor 5 is interposed between a front end of the right seat lower frame 13 and a front end of the right seat upper frame 14 and works to measure the weight load of the occupant applied to a front right portion of the seat 1 and outputs a signal indicative thereof to the seat occupant identifying ECU 6.

Each of the load sensors 2 to 5 may be of any of known structures, and explanation thereof in detail will be omitted here.

The seat occupant identifying ECU 6, as clearly shown in FIG. 2, includes a CPU 61, a noise-resistant circuit 62, an EEPROM 63, an communications I/F 64, and a power supply circuit 65. The noise-resistant circuit 62 works to remove electrical disturbances or noises added to lines, as labeled “Vcc”, “Vout”, and “GND” in the drawing. The EEPROM 63 stores therein threshold values, as will be described later in detail. The I/F 64 connects between the CPU 61 and the airbag ECU 7 electrically to establish communication therebetween. The power supply circuit 65 is designed to convert the voltage developed by a storage battery installed in the vehicle into +5V. The seat occupant identifying ECU 6 is, as can be seen in FIG. 1, mounted on the floor pan of the vehicle body.

The seat occupant identifying ECU 6 works to determine the presence or the type of the occupant on the seat 1 (i.e., an adult or a child), detect the attitude or position of the occupant on the seat 1 immediately before a vehicle collision, and provides signals indicative thereof to the airbag ECU 7 through the I/F 64.

The airbag ECU 7 receives the signals transmitted from the seat occupant identifying ECU 6, i.e., information on the presence, the type, and the position of the occupant on the seat 1 and controls the deployment of the airbag installed within, for example, a dashboard of the vehicle.

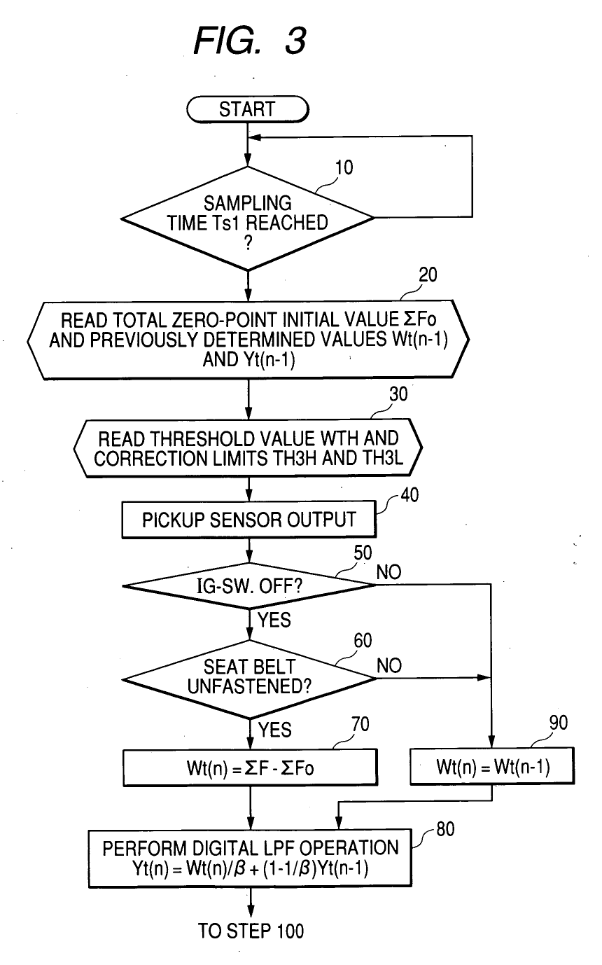

The operation of the seat occupant identifying ECU 6 will be described below with reference to FIGS. 3 to 5.

FIGS. 3 and 4 show a flowchart of a sequence of logical steps or program executed by a microcomputer constituting the ECU 6 to compensate for errors in outputs of the load sensors 2 to 5 arising from aging of the load sensors 2 to 5 and/or the seat 1. This is achieved by correcting an adult identifying threshold value WTH which is used for comparison with the sum of outputs of the load sensors 2 to 5 to identify the type of an occupant on the seat 1, that is, whether the occupant is an adult or a child.

After entering the program, the routine proceeds to step 10 wherein it is determined whether a preselected sampling time Ts1 has been reached or not. This determination is achieved by monitoring a count value of a timer installed in a sub-CPU. The sampling time Ts1 is, for example, several tens of minutes or several hours. If a YES answer is obtained, then the routine proceeds to step 20 wherein a total zero-point initial value ΣF₀ and previously determined values Wt (n−1) and Yt (n−1), as will be referred to later in detail, are read out of the EEPROM 36. Note that n is a program cycle number.

The routine proceeds to step 30 wherein an adult identifying threshold value WTH and upper and lower limits TH3H and TH3L used to correct the adjust identifying threshold value WTH, and a given constant used in a digital LPF (low-pass filter) operation are read out of the EEPRON 36. Note that the adult identifying threshold value WTH is preselected to a value of, for example, 35 kg derived by subtracting 5 kg from 40 kg which is expected as the sum of outputs of all the load sensors 2 to 5 when, for example, a smaller size adult of 50kg is sitting on the seat 1 with his or her legs resting on the floor of the vehicle

The routine proceeds to step 40 wherein outputs of the load sensors 2 to 5 are monitored and stored as F1, F2, F3, and F4.

The routine proceeds to step 50 wherein it is determined whether an ignition switch of an automotive vehicle equipped with the occupant restraint system 100 is turned off or not. If a YES answer is obtained meaning that the ignition switch is in an off-state, then the routine proceeds to step 60 wherein a seat belt of the seat 1 is unfastened or not by monitoring, for example, an output of a seat belt switch. If a YES answer is obtained meaning that the seat belt is in an unfastened position, then the routine proceeds to step 70. When the ignition switch is in the off-position, and the seat belt is in the unfastened position, that is, when positive answers are obtained both in steps 50 and 60, the occupant restraint system 100 determines that the seat 1 is unoccupied by a vehicle passenger and prohibits the airbag for the seat 1 from deploying.

In step 70, a zero-point deviation Wt(n) is determined according to an equation of Wt(n)=ΣF−ΣF₀ where ΣF is the sum of outputs F1, F2, F3, and F4 of the load sensors 2 to 5, as derived in step 40, and ΣF₀ is the sum of initial values of outputs F1₀, F2₀, F3₀, and F4₀ of the load sensors 2 to 5 prestored in the EEPROM 36 by a manufacturer of the occupant restraint system 100 and read out of the EEPROM 36 in step 20. Specifically, the initial values represent manufacturer-preset reference values (i.e., zero points) that are outputs of the load sensors 2 to 5 when the seat 1 is unoccupied by any person, and only the weight of the seat 1 is applied to the load sensors 2 to 5. Accordingly, the zero-point deviation Wt(n) represents a drift of a total value of actual outputs of the load sensors 2 to 5 from a total value of the manufacturer-preset reference values and is derived as a function of the degree of aging of the load sensors 2 to 5.

After step 70, the routine proceeds to step 80 to perform an averaging operation on the zero-point deviation Wt(n) to estimate or predict the degree of aging of the load sensors 2 to 5. Specifically, the digital low-pass filtering is performed logically according to an equation below to remove electrical disturbances from the zero-point deviation Wt(n) to produce a sensor aging parameter Yt(n) (i.e. an output of the digital LPF).

Yt(n)={Wt(n)/β}+{1−(1β)}×{Yt (n−1)}

where β=Fs1/(2π·Fc1), Fs1 is a sampling cycle (Fs1=1/Ts1), Fc1 is a cut-off frequency (Fc1=1/Tlpf) , and Tlpf is a time constant preselected from a range of several months to several years. The time constant Tlpf may preferably be preset to an initial value of one year and changed consecutively or stepwise as a function of an elapsed time since manufacture of the system-equipped vehicle (i.e., the occupant restraint system 100). For example, the time constant Tlpf may be increased at a constant rate or in units of several months every two or three years. The selection of the value of the time constant Tlpf is preferably made for the purposes of minimizing the response rate of the digital LPF for a change in output of the load sensors 2 to 5 arising from loading of packages into the vehicle and ensuring a desired response of the digital LPF to a change in output of the load sensors 2 to 5 caused by the aging thereof. It may also be made for assuring the desired responsibility of the digital LPF to a change in output of the load sensors 2 to 5 due to environmental factors such as a change in ambient temperature. The setting of the time constant Tlpf to one year establishes a desired response to a change in output of the load sensors 2 to 5 caused by the changes in ambient temperature as well as the aging of the load sensors 2 to 5, thereby resulting in increased accuracy of correcting the adult identifying threshold value.

The current sensor aging parameter Yt(n) and the previous sensor aging parameter Yt(n−1), as derived one program cycle earlier are preferably expressed using the number of digits enough to ensure desired accuracy. An initial value of Yt(n−1) is set to zero (0).

If a NO answer is obtained in step 50 meaning that the ignition switch is in an on-state or in step 60 meaning that the seat belt is fastened, the routine proceeds to step 90. Specifically, if a NO answer is obtained in step 50 or 60, the occupant restraint system 100 determines that the probability that the seat 1 is occupied by a vehicle passenger is high. In step 90, the zero-point deviation Wt(n−1) derived one program cycle earlier is determined as the current zero-point deviation Wt(n). The routine then proceeds to step 80, as discussed above.

After step 80, the routine proceeds to step 100, as illustrated in FIG. 4, wherein it is determined whether the sensor aging parameter Yt(n) lies within a correction allowable range between the upper and lower correction limits TH3H and TH3L or not. If a YES answer is obtained meaning that TH3L≦Yt(n)≦TH3H, then the routine proceeds to step 110. Alternatively, if a NO answer is obtained, then the routine proceeds to step 160. Step 100 may alternatively determine whether an absolute value of the sensor aging parameter Yt(n) is smaller than the upper limit TH3H or not. Note that the upper and lower correction limits TH3H and TH3L are determined by upper and lower possible limits of the aging parameter Yt(n).

In step 110, a correction value ΔW₀ is set to the sensor aging parameter Yt(n). The routine proceeds to step 120 wherein the adult identifying threshold value WTH is corrected using the correction value ΔW₀ to compensate for a deviation of a total of actual outputs (i.e., zero-points) of the load sensors 2 to 5 when the seat 1 is unoccupied from the total zero-point initial value ΣF₀ preset by the manufacturer of the occupant restraint system 100 when the system-equipped vehicle was produced, which usually arises from the aging of the load sensors 2 to 5. Specifically, the correction value ΔW₀ is added to the adult identifying threshold value WTH to produce an updated one.

The routine proceeds to step 130 wherein the sensor aging parameter Yt(n) and the zero-point deviation Wt(n) are set to Yt(n−1) and Wt(n−1), respectively.

The routine proceeds to step 140 wherein the adult identifying threshold value WTH, the sensor aging parameter Yt(n−1), and the zero-point deviation Wt(n−1) are stored in the EEPROM 36.

The routine proceeds to step 150 wherein the count value of the timer of the sub-CPU showing the sampling time Ts1 is reset to zero (0).

If a NO answer is obtained in step 100 meaning that the sensor aging parameter Yt(n) lies out of the correction allowable range between the upper and lower correction limits TH3H and TH3L, then the routine proceeds to step 160 wherein it is determined whether the sensor aging parameter Yt(n) is greater than the upper correction limit TH3H or not. If a YES answer is obtained meaning that Yt(n)>TH3H, then the routine proceeds to step 170 wherein the correction value ΔW₀ is set to the upper correction limit TH3H. Alternatively, if a NO answer is obtained, then the routine proceeds to step 180 wherein the correction value ΔW₀ is set to the lower correction limit TH3L.

After step 170 or 180, the routine proceeds to step 120, as described above.

The adult identifying threshold value WTH thus determined is used, as described above, to identify whether an occupant on the seat 1 is an adult or a child. Specifically, the sum of outputs of the load sensors 2 to 5 is compared with the adult identifying threshold value WTH. If the sum is greater than the adult identifying threshold value WTH, the seat occupant identifying ECU 6 determines that the occupant on the seat 1 is an adult passenger and adjusts the deployment of the airbag to a degree matching the adult passenger through the airbag ECU 7 upon occurrence of a vehicle collision.

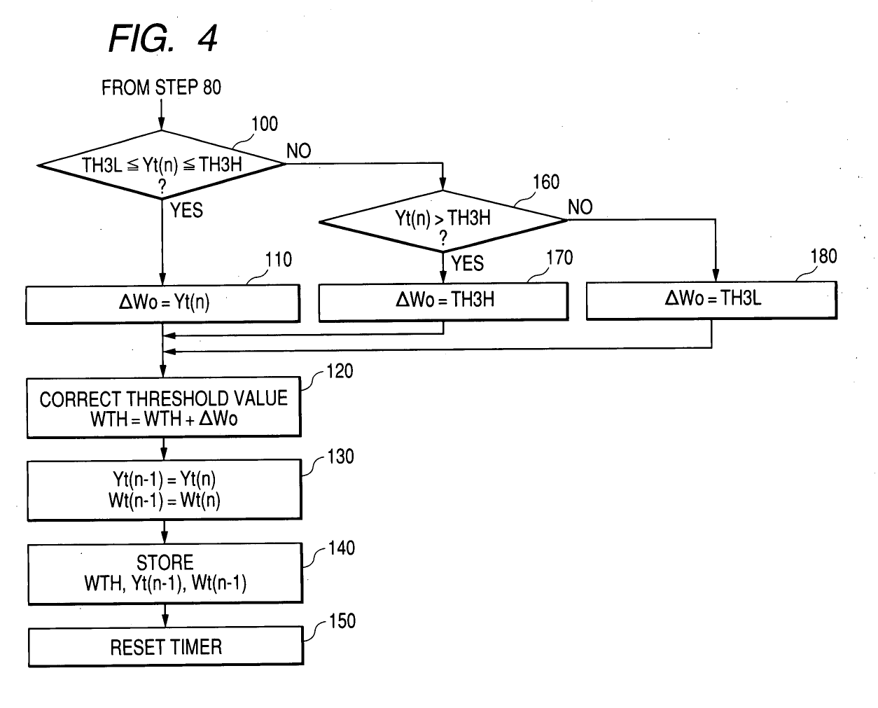

The sum of actual outputs of the load sensors 2 to 5 when the seat 1 is unoccupied by any person (i.e., the total load ΣF), as clearly shown in FIG. 5, increases with time from the total zero-point initial value ΣF₀ preset by the manufacturer of the occupant restraint system 100. This may result in an error in determining the type of an occupant on the seat 1. Such an error, that is, a sensor aging-caused deviation (i.e., the aging parameter Yt(n)) of outputs of the load sensors 2 to 5 from correct ones is minimized by correcting the adult identifying threshold value WTH using the correction value ΔW₀ determined as a function of the degree of aging of the load sensors 2 to 5.

The seat occupant identifying ECU 6 also limits the correction value ΔW₀ to within the correction allowable range in steps 100, 160, and 180 in FIG. 4. Specifically, when the correction value ΔW₀ lies out of the correction allowable range, it is set to the upper limit TH3H or the lower limit TH3L. This prevents a change in the sum of outputs of the load sensors 2 to 5 (i.e., total load ΣF), which is actually taken place in a condition below, from being determined as having arisen from the aging of the load sensors 2 to 5, which results in an excessive increase in the correction value ΔW₀. Such a change occur, for example, in a case where baggage is placed on the seat 1 for a long time or a foreign matter is caught in a frame of the seat 1.

The seat occupant identifying ECU 6 determines the probability of occupancy of the seat 1 based on decisions in steps 50 and 60 of FIG. 3 that the ignition switch of the system-equipped vehicle is turned on and that the seat belt is fastened. The determination of whether the seat 1 is now being occupied or not is, therefore, achieved by an inexpensive and simple structure.

Only one load sensor may be used to measure the weight load of an occupant on the seat 1 for identifying whether the occupant is an adult or a child. In this case, a value of the total load ΣF, as used in step 70 of FIG. 3, is replaced with an output of that load sensor.

The determination of whether the seat 1 is now being occupied or not may alternatively be made using a camera such as a CCD camera installed within a vehicle cabin to monitor the presence or absence of an occupant on the seat 1.

While the present invention has been disclosed in terms of the preferred embodiments in order to facilitate better understanding thereof, it should be appreciated that the invention can be embodied in various ways without departing from the principle of the invention. Therefore, the invention should be understood to include all possible embodiments and modifications to the shown embodiments which can be embodied without departing from the principle of the invention as set forth in the appended claims.

What is claimed is:

1. A seat occupant identifying apparatus for a vehicle comprising:
a load sensor responsive to a physical load acting on a seat of a vehicle which arises from occupancy of the seat by a passenger to provide an output indicative thereof;
a seat occupant identifying circuit working to identify the passenger on the seat based on comparison of the output of said load sensor with a passenger identifying threshold value;
an aging-caused drift estimating circuit working to estimate an aging-caused drift of an actual output of said load sensor when the seat is unoccupied which arises from aging of said load sensor; and
a threshold correcting circuit working to correct the passenger identifying threshold value based on the aging-caused drift estimated by said aging-caused drift estimating circuit.

2. A seat occupant identifying apparatus as set forth in claim 1, wherein said aging-caused drift estimating circuit is designed to perform a sampling function of sampling an output of said load sensor in a given sampling cycle, a seat unoccupancy determining function of determining whether the seat is unoccupied or not every sampling cycle, an averaging function of averaging the outputs of said load sensor sampled by the sampling function when it is determined by the seat unoccupancy determining function that the seat is unoccupied to produce an average value, and an aging-caused drift estimating function of estimating the aging-caused drift based on the average value.

3. A seat occupant identifying apparatus as set forth in claim 2, wherein said aging-caused drift estimating circuit is implemented by a microcomputer which is actuated every sampling cycle regardless of a position of an ignition switch of the vehicle.

4. A seat occupant identifying apparatus as set forth in claim 1, wherein said threshold correcting circuit corrects the passenger identifying threshold value using a correction value which is provided by the aging-caused drift estimated by said aging-caused drift estimating circuit, and wherein the correction value is limited to within a range between an upper and a lower limit of the aging-caused drift.

5. A seat occupant identifying apparatus as set forth in claim 2, wherein the seat unoccupancy determining function determines that the seat is being unoccupied when at least one of conditions are encountered in which an ignition key of the vehicle is in an off-state and in which a seat belt for the seat is unfastened.

6. A seat occupant identifying apparatus as set forth in claim 2, wherein the averaging function is implemented by a digital low pass filter.

7. A seat occupant identifying apparatus as set forth in claim 6, wherein a time constant used in the digital low pass filter is selected from a range of several months to several years.

8. A seat occupant identifying apparatus as set forth in claim 7, wherein the time constant is changed continuously or stepwise as a function of an elapsed time since the passenger identifying threshold value is preset by a manufacturer of the seat occupant identifying apparatus.
